(19) United States
(12) Patent Application Publication
(10) Pub. No.: US 2003/0053751 A1
(43) Pub. Date: Mar. 20, 2003

(54) Thermally-formed lensed fibers

(76) Inventors: Ljerka Ukrainczyk, Painted Post, NY (US); Debra L. Vastag, Elmira Heights, NY (US)

Correspondence Address: CORNING INCORPORATED, SP-TI-3-1, CORNING, NY, 14831

(21) Appl. No.: 10/170,762

(22) Filed: Jun. 12, 2002

Related U.S. Application Data
(60) Provisional application No. 60/298,841, filed on Jun. 15, 2001.
(60) Provisional application No. 60/352,753, filed on Jan. 28, 2002.

(51) Int. Cl. G02B 6/32

(52) U.S. Cl. 385/33

(57) ABSTRACT

A focusing lensed fiber includes an optical fiber terminated with a lens. The lens has a distance to beam waist greater than Rayleigh range. A method for forming a lensed fiber includes resistibly heating a selected region of a glass fiber for a predetermined time and pulling on the glass fiber while resistibly heating to form a convex surface at the selected region.

### CROSS-REFERENCE TO RELATED APPLICATIONS

This application claims priority from U.S. Provisional Application Serial No. 60/298,841, entitled “Thermally Formed Lensed Fibers for Imaging and Condenser Applications,” filed Jun. 15, 2001, of Ukrainczyk et al., and No. 60/352,753, entitled Thermally Formed Lensed Fibers, filed Jan. 28, 2002, of Ukrainczyk et al.

### BACKGROUND OF INVENTION

1. Field of the Invention

The invention relates generally to methods and devices for coupling light between optical fibers and optical devices in optical communication networks. More specifically, the invention relates to a focusing lensed fiber and a method for forming lensed fibers.

2. Background Art

A lensed fiber is a monolithic device having an optical fiber terminated with a lens. Lensed fibers are advantageous because they are easy to assemble, i.e., they do not require active fiber-lens alignment and gluing of fiber to lens, they have low insertion loss, and they enable component miniaturization because they can be made very small. The coefficient of thermal expansion of the lens can be matched to that of the optical fiber to achieve better performance over a temperature range. Lensed fibers are easily arrayed and are therefore desirable for making arrayed devices, for use in silicon optical bench applications, and for aligning optical fibers to planar waveguides. In addition, the spot size and working distance of the lensed fiber can be tailored for a specific application. For example, the spot size and working distance of the lensed fiber can be tailored to produce smaller beam diameters that can allow use of smaller micro-electro-mechanical systems (MEMS) mirrors in optical switches.

There are various types of lensed fibers. FIG. 1 shows a prior-art collimating lensed fiber having a planoconvex lens 1 fusion-spliced to one end of an optical fiber 2. The optical fiber 2 could be a single-mode or a multimode fiber. The planoconvex lens 1 is typically formed from a coreless fiber. The front surface of the planoconvex lens 1 is shaped like a sphere and acts as a collimator, expanding light coming out of the optical fiber 2 into a collimated beam. The collimating lensed fiber can be used for collimation over a wide range of distances. One main use of the collimating lensed fiber is to couple light from one optical fiber to another optical fiber.

There are various methods for forming a collimating lensed fiber. One method involves melting an end portion of an optical fiber to form a spherical surface with a desired radius of curvature. Typically, the melting process involves creating an electric arc between a pair of electrodes placed on opposite sides of the end portion of the optical fiber. The electric arc melts the end portion of the optical fiber to form the spherical surface. Alternatively, a laser beam may be used to melt the end portion of the optical fiber to form the spherical surface. Another method for forming the collimating lensed fiber involves splicing a coreless fiber having a spherical surface to an optical fiber. The coreless fiber with the spherical surface then acts as the lens.

FIG. 2 shows a tapered lensed fiber having a taper 4 formed at a tip of an optical fiber 3. The optical fiber 3 could be a single-mode or a multimode fiber. The taper 4 has a convex surface 5 that acts as a lens. The radius of curvature of the convex surface 5 is very small in comparison to that of the planoconvex lens (1 in FIG. 1) of the collimating lensed fiber. The taper 4 can be achieved by grinding and/or polishing the tip of the optical fiber 3. The tapered lensed fiber collimates light over a short working distance. The tapered lensed fiber can be used for coupling light between an optical fiber and a laser source or an optical amplifier or a planar waveguide.

### SUMMARY OF INVENTION

In one aspect, the invention relates to a focusing lensed fiber which comprises an optical fiber terminated with a lens. The lens has a distance to beam waist greater than Rayleigh range.

In another aspect, the invention relates to a method for forming a lensed fiber which comprises resistibly heating a selected region of a glass fiber for a predetermined time and pulling on the glass fiber while resistibly heating to form a convex surface at the selected region.

Other features and advantages of the invention will be apparent from the following description and the appended claims.

### BRIEF DESCRIPTION OF DRAWINGS

FIG. 1 is a schematic of a prior art collimating lensed fiber.

FIG. 2 is a schematic of a prior art tapered lensed fiber.

FIGS. 3A-3C show various embodiments of a focusing lensed fiber according to an embodiment of the invention.

FIGS. 4A and 4B show Gaussian beam ray trace analysis for beam propagating in 100-μm air followed by propagation in InGaAs (n=3.18) for various focusing lensed fiber geometries.

FIGS. 5A and 5B illustrate a method for forming a radius of curvature on a glass fiber.

FIG. 5C shows the glass fiber of FIG. 5B after taper-cutting with a resistive filament.

FIG. 6 shows a tapered lensed fiber formed by a method of the invention.

FIG. 7 illustrates the definition of the f-number of a lens.

FIG. 8 shows mode field diameter as a function of distance from the convex surface of a focusing lens.

FIGS. 9A and 9B show mode field shape (magnified 10×) at the beam waist for x and y components, respectively, of a focusing lens.

FIG. 10 shows angular radiation intensity as a function of radius of curvature for a tapered lensed fiber.

FIGS. 11A-11D show mode field diameter as a function of distance from lens surface for various tapered lens geometries.

### DETAILED DESCRIPTION

Embodiments of the invention provide a focusing lensed fiber that focuses light coming out of an optical fiber into a spot larger than, equal to, or smaller than the mode field diameter (MFD) of the fiber. The focusing lensed fiber can be used for focusing and condenser applications. Embodiments of the invention provide a method for forming the focusing lensed fiber. More specifically, embodiments of the invention provide a method for forming a precise radius of curvature at the tip of an optical fiber or, more generally, a glass fiber. The method allows for the formation of a planoconvex lens with a wide range of prescriptions at the end of an optical fiber. This allows the spot size and working distance of the lensed fiber to be tailored to specific applications. The method can also be used to form a tapered lensed fiber. The tapered lensed fiber can be used for focusing and condenser applications as well as collimation over short working distances. Specific embodiments of the invention are described below with reference to the accompanying drawings.

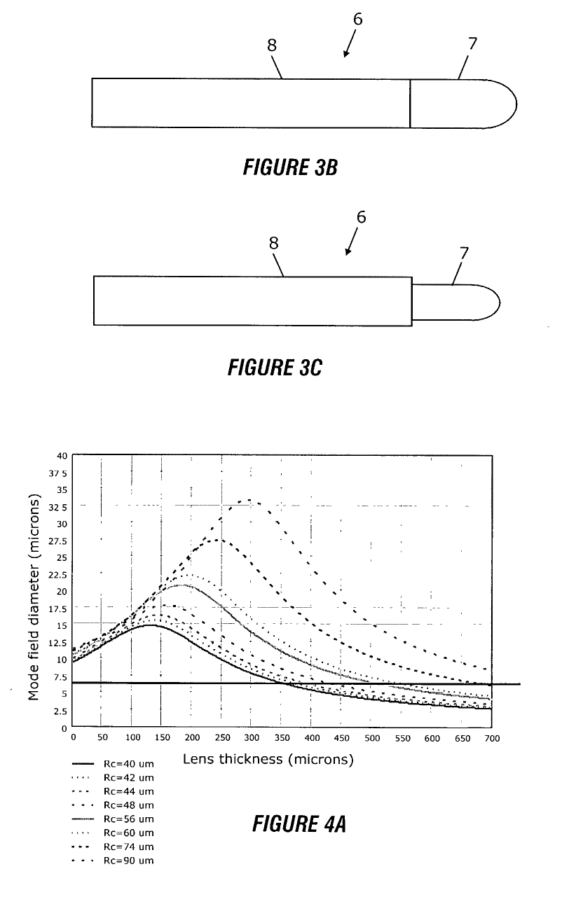

FIG. 3A shows a focusing lensed fiber 6 having a planoconvex lens 7 attached to an optical fiber 8. The planoconvex lens 7 may be attached to the optical fiber 8 by fusion-splicing. The optical fiber 8 has a core 9 and a cladding 10 surrounding the core 9. The optical fiber 8 could be any single-mode fiber, including polarization-maintaining (PM) fiber, or a multimode fiber. In the illustration, the optical fiber 8 is shown as a single-mode fiber. The diameter of the planoconvex lens 7 is shown as being larger than the diameter of the optical fiber 6. However, this is not a requirement. The diameter of the planoconvex lens 7 could be the same as the diameter of the optical fiber 8 (see FIG. 3B) or could be smaller than the diameter of the optical fiber 8 (see FIG. 3C). Typically, the planoconvex lens 7 is made from a glass fiber with no waveguiding core. The glass fiber and the optical fiber 8 may be made using the same fiber fabrication process. Typically, the planoconvex lens 7 is made of silica or doped silica, e.g., B₂O₃—SiO₂ and GeO₂—SiO₂, and has a refractive index similar to the refractive index of the core 9. The planoconvex lens 7 is typically coated with an anti-reflective coating to minimize back-reflection. A back-reflection greater than −55 dB is generally desirable.

In operation, a light beam traveling down the core 9, diverges upon entering the planoconvex lens 7, and is focused into a spot upon exiting the planoconvex lens 7. The radius of curvature (Rc) and the thickness (T) of the lens 7 are selected such that the distance (f) from the convex surface of the planoconvex lens 7 to the beam waist is greater than Rayleigh range. Rayleigh range is the axial distance around beam waist for which the beam radius is within a factor of \sqrt{2} of its minimum value. Rayleigh range is calculated using the following expression:

$${z}_{0} = \frac{2 π {w}_{0}^{2}}{λ} \qquad 1$$

where z₀ is Rayleigh range, w₀ is the radius of beam waist, and λ is wavelength. By making the distance to beam waist (f) greater than Rayleigh range, the beam produced by the planoconvex lens 7 is placed outside of the Rayleigh range, allowing the planoconvex lens 7 to act as a focuser or condenser. In general, the following condition should hold for the lens:

$$\frac{T}{Rc} > \frac{n}{n + 1} + Φ \qquad 2$$

where T is the thickness of the lens, Rc is the radius of curvature of the lens, n is the refractive index of the lens at the wavelength of interest, and Φ is phase shift due to diffraction of the small Gaussian beam.

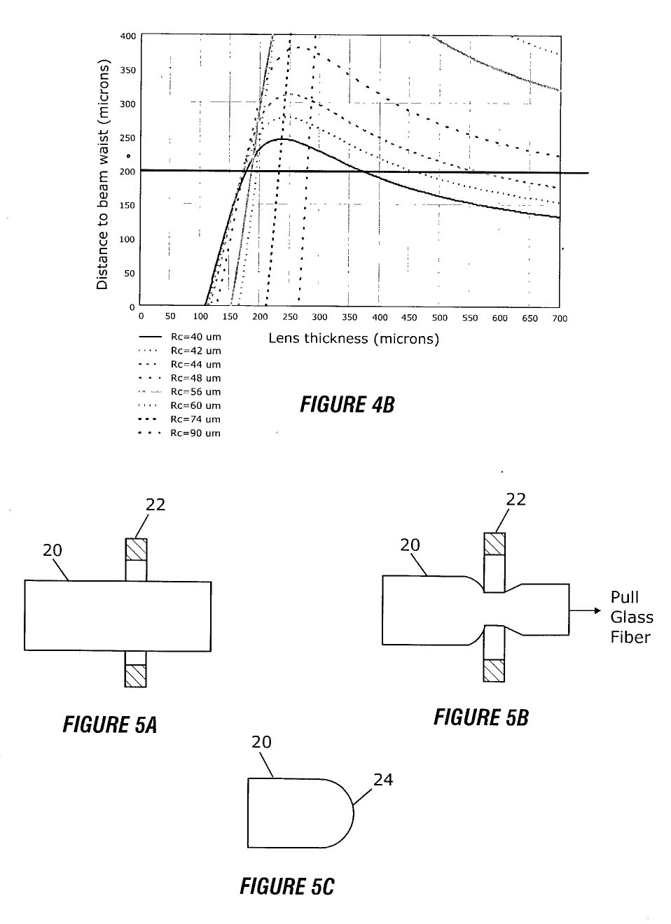

The spot size, or mode field diameter (MFD), of the focusing lensed fiber 6 is determined by the thickness (T), radius of curvature (Rc), and distance to beam waist (f) of the planoconvex lens 7. For illustration purposes, a Gaussian beam ray trace analysis for beam propagating in 100-μm air followed by propagation in InGaAs (n=3.18) for various focusing lensed fiber geometries is shown in FIGS. 4A and 4B. FIG. 4A shows mode field diameter (MFD) as a function of lens thickness and radius of curvature of the lens. FIG. 4B shows distance to beam waist as a function of thickness and radius of curvature of the lens. The goal for the lens geometries in FIGS. 4A and 4B was to image Corning®) SMF-28 optical fiber core onto an optical detector area of 10 μm diameter. The optical detector was buried inside 100 μm of semiconductor with index of refraction of 3.18. Calculations showed that a 16-μm spot in air would correspond to slightly less than 10 μm if the beam travels through a high-index material above. The modeling assumed a 6.3 μm Gaussian mode field radius for the optical fiber core. The assumed mode field radius is larger than the 5.2 μm nominal mode field radius of SMF-28 because splicing and lens formation result in thermal core broadening.

Returning to FIG. 3A, the geometry of the planoconvex lens 7 is preferably selected such that the beam diameter at the point where the beam exits the planoconvex lens 7 does not exceed the diameter of the planoconvex lens 7; otherwise, resonance and waveguiding effects could occur. In general, the diameter (D) of the planoconvex lens 7 at the point where the beam exits the planoconvex lens 7 can be estimated as follows:

D≧2·w_{d} 2

where

w_{d}=dθ_{beam} 3

and

$${θ}_{beam} = \frac{λ}{π {w}_{o} n} \qquad 4$$

where w_{d} is the mode field radius at the point where the beam exits the lens, d is the point where the beam exits the lens, θ_{beam} is angular spread of Gaussian beam outside Raleigh range, λ is wavelength of light, wₒ is mode field radius at the beam waist, and n is the refractive index at the wavelength of interest.

To achieve a symmetrical mode field, formation of the radius of curvature (Rc) of the planoconvex lens 7 should be carefully controlled. FIG. 5A illustrates a method for forming a precise radius of curvature on any glass fiber, e.g., glass fiber 20. The glass fiber 20 could be a coreless fiber that will be shaped into a planoconvex lens or the tip of a single-mode or multimode fiber that will be shaped into a lens. The method of the invention involves placing a heat source 22 at a desired position along the glass fiber 20. The position of the heat source 22 along the glass fiber 20 determines the thickness of the lens. As shown in FIG. 5B, the heat source 22 is operated to deliver a controlled amount of heat to the glass fiber 20 while pulling on the glass fiber 20 in the direction indicated by the arrow. The glass fiber 20 is taper-cut as it is heated and pulled to form a convex surface (24 in FIG. 5C) having a desired radius of curvature. The heat source 22 in FIG. 5B is a resistive filament that delivers very uniform heat to the glass fiber 20, allowing for the formation of a spherical lens with a symmetrical mode field.

Turning to FIG. 5C, the radius of curvature of the convex surface 24 depends on the power supplied to the resistive filament (22 in FIG. 5B). Typical power used for taper-cutting the glass fiber 20 is in a range from 22 to 30W, depending on the desired radius of curvature. The radius of curvature of the convex surface 24 can also be affected by the duration of heating by the resistive filament (22 in FIG. 5B). In general, the longer the heating time after taper-cutting the glass fiber 20, the larger the radius of curvature. The radius of curvature can be further enlarged after taper-cutting by placing the resistive filament (22 in FIG. 5B) in front of the convex surface 24 and moving the resistive filament (22 in FIG. 5B) towards the convex surface 24 as the convex surface 24 is melted by the heat from the resistive filament (22 in FIG. 5B). This process is referred to as melt-back. The heat applied to the convex surface 24 and the duration of the heating are controlled to obtain the desired radius of curvature.

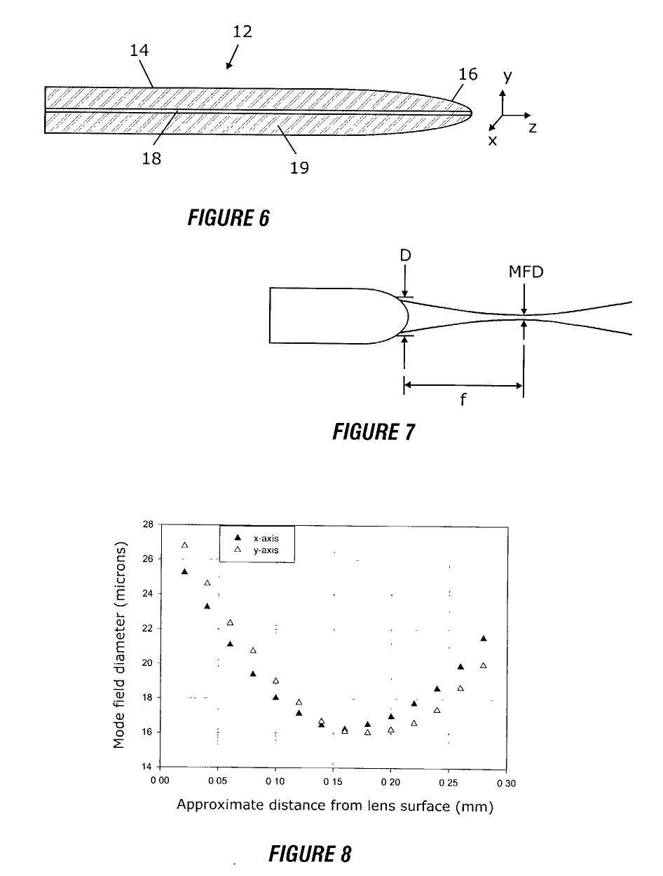

A focusing lensed fiber can be formed by splicing a glass fiber to an optical fiber, as in a typical splicing of two optical fibers. A resistive filament or other suitable heat source, such as an electric arc, can be used to splice the glass fiber to the optical fiber. Although the preferred method is to use resistive heating to attach the glass fiber to the optical fiber, other means of attachment, such as laser welding, can also be used. After attaching the glass fiber to the optical fiber, the glass fiber can be resistibly heated and pulled as described above to form a radius of curvature on the glass fiber. A tapered lensed fiber can be formed by resistibly heating and pulling on the tip of an optical fiber, as described above for the glass fiber, to form a desired radius of curvature at the tip of the optical fiber. FIG. 6 shows a tapered lensed fiber 12 formed by the method of the invention. The tapered lensed fiber 12 has an optical fiber 14 with a taper 16 having a desired radius of curvature, wherein the taper 16 acts as a lens. The optical fiber 14 has a core 18 surrounded by a cladding 19. In general, the optical fiber 14 may be any single-mode fiber, including PM fiber, or a multimode fiber.

The main distinctions between the tapered lensed fiber 12 (shown in FIG. 6) and the focusing lensed fiber 6 (shown in FIGS. 3A-3C) are the distance to beam waist and the f-number, or speed, of the planoconvex lens 7 (shown in FIGS. 3A-3C) and lens (or taper) 16 (shown in FIG. 6). The definition of the f-number of a lens is explained with reference to FIG. 7. The f-number of a lens is defined as the ratio of the distance to beam waist (f) of the lens to the clear aperture (D), or effective diameter, of the lens. Typically, the effective diameter (D) is 99% of the diameter of the beam at the convex surface of the lens. The distance to beam waist (f) for a tapered lensed fiber is typically in a range from about 5 to 50 μm, while the distance to beam waist (f) for a focusing lensed fiber of comparable mode field diameter at the beam waist is typically greater than 100 μm. The f-number of the tapered lensed fiber is small, usually around 1, while the f-number of the focusing lensed fiber is much greater than 1.

Both the focusing lensed fiber 6 (shown in FIGS. 3A-3C) and the tapered lensed fiber 12 (shown in FIG. 6) can be used for focusing and condenser applications. The tapered lensed fiber 12 can also be used to collimate light over a short working distance. Generally speaking, the focusing lensed fiber 6 (shown in FIGS. 3A-3C) is well suited for focusing a beam onto an optical detector or receiver and for coupling light from vertical cavity surface emitting lasers (VCSELs) into an optical fiber. The tapered lensed fiber 12 (shown in FIG. 6) is well suited for coupling light in and out of optical fiber into high numerical aperture planar waveguides as well as VCSELs and other laser sources with circular or nearly circular beam. Because of the high f-number, focusing lensed fibers tend to be more sensitive to angular misalignment compared to tapered lensed fiber with the same mode field diameter. Coupling efficiency with focusing lensed fibers is typically greater than 99%. Coupling efficiency with tapered lensed fiber is typically greater than 80%.

Examples of focusing lensed fiber geometries formed using the method described above are shown in Table 1. However, it should be clear that the examples presented in Table 1 are for illustration purposes only and are not to be construed as limiting the invention in anyway. For the lensed fiber geometries shown in Table 1, a coreless fiber was spliced to a single-mode fiber, and the coreless fiber was taper-cut to form a planoconvex lens using the method described above. The coreless fiber was a 200-μm borosilicate rod, and a fusion splicer sold under the trade name FFS-2000 by Vytran Corporation of Morganville, N.J., was used to taper-cut the coreless fiber. The fusion splicer included a tungsten filament for heating the coreless fiber. Table 1 shows the power conditions used in taper-cutting the coreless fiber. Also shown in Table 1 is the mode field diameter (MFD) at the beam waist, the distance to beam waist, and Rayleigh range for the lens. The measurements were made at 1545 nm.

TABLE 1
Relationship between process parameters and focusing lensed fiber
geometries

| | | | | MFD at | | |
|---|---|---|---|---|---|---|
| | | | Filament | Beam | Distance | Ray- |
| | Lens | Radius of | Power for | Waist | to Beam | liegh |
| | Thickness, | Curvature, | Tapering | (μm) in | Waist | Range |
| Lens | T (μm) | Rc (μm) | (W) | Air | (μm) | (μm) |
| A | 601 | 74 | 25.3 | 7.7 | 270 | 15 |
| B | 644 | 89 | 27.0 | 9.4 | 350 | 22.5 |
| C | 276 | 56 | 22.0 | 15.5 | 234 | 60 |
| D | 205 | 48 | 21.8 | 16.1 | 170 | 66 |
| E | 425 | 44 | 21.5 | 5.6 | 143 | 8.5 |
| F | 300 | 40 | 21.0 | 7.8 | 140 | 15 |

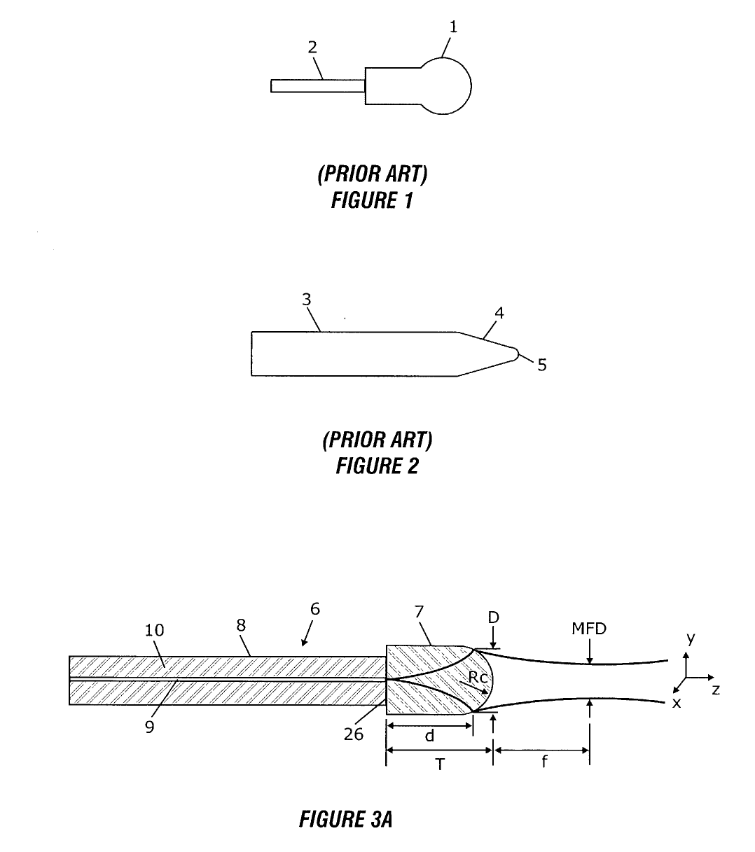

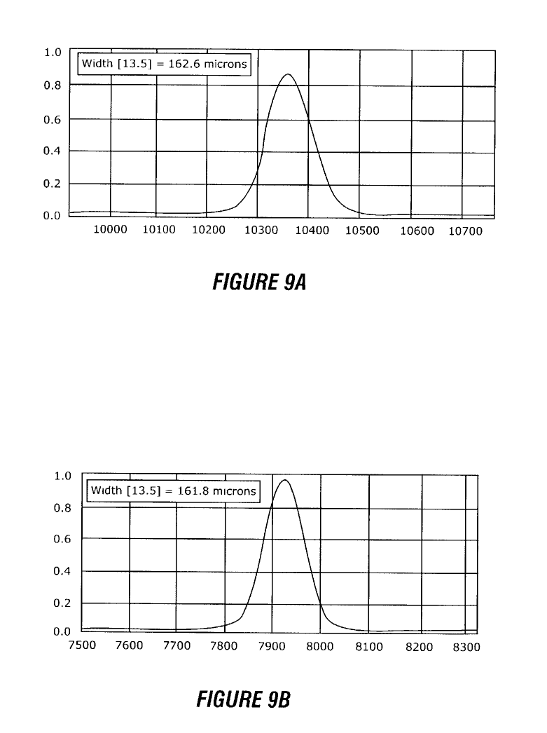

FIG. 8 shows mode field diameter along the x and y axes (see FIG. 3A) as a function of distance along the z-axis (see FIG. 3A) for lens D (see Table 1). The zero point on the z-axis (see FIG. 3A) was estimated from divergence angle in the lens of the beam emerging at the splice (see element 26 in FIG. 1A) formed between the fiber and the lens. FIGS. 9A and 9B show the x and y components of the mode field shape, respectively, at the beam waist for the lens D (see Table 1). The beam measurements were taken with a beam scan using 10 times objective at a numerical aperture of 0.25. Thus, the actual mode field diameter is ten times smaller, i.e., 16 μm instead of approximately 160 μm.

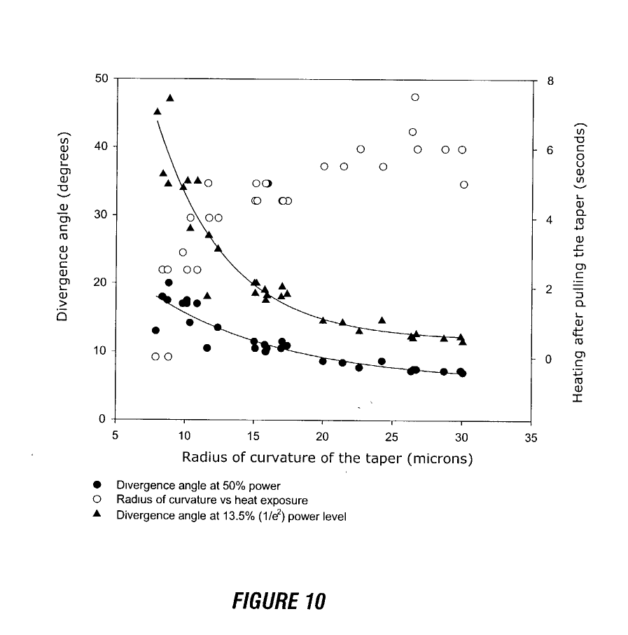

FIG. 10 shows angular intensity as a function of radius of curvature for a tapered lensed fiber. The tapered lensed fiber was formed by pulling an optical fiber into a taper while heating the optical fiber. The optical fiber was resistively heated using a fusion splicer such as sold under the trade name FFS-2000 by Vytran Corporation of Morganville, N.J. The radius of curvature formed at the end of the taper was proportional to the length of time the fiber was exposed to the resistive heating. The angular radiation intensity reported in FIG. 10 was measured in far field by scanning from +72 to −72 degrees using a goniometric radiometer LD 8900, available from Photon Inc. The tapered lensed fiber was formed from a Corning® SMF-28 fiber, and measurements were made using a broadband erbium amplified spontaneous emission laser source. The graph shows a strong dependence between divergence angle and radius of curvature of the taper (black symbols, left-hand y-axis). In addition, the graph shows strong dependence between process parameters (heating time at 24.4 W power on FFS-2000 Vytran fusion splicer) and radius of curvature (open circles, right-hand y-axis). The far-field divergence angle at 1/e² power level (θ) and the mode field radius at beam waist (wₒ) of the taper at the waist can be related using θ=λ/(πwₒ).

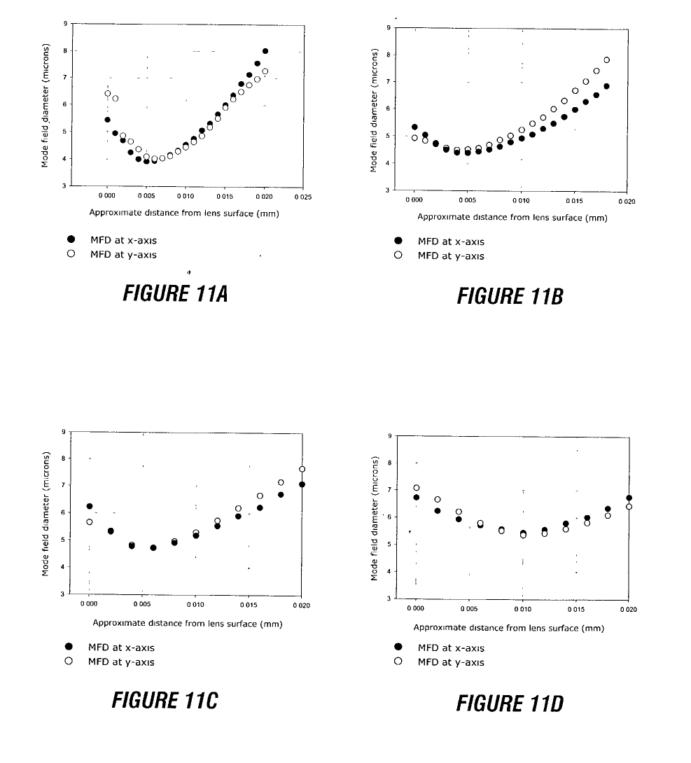

FIGS. 11A-11D show mode field diameter (MFD) as a function of distance from the convex surface of lens for four different tapered lensed fiber geometries. The shaded circles represent the mode field diameter along the x-axis (see FIG. 6), while the circles not shaded represent the mode field diameter along the y axis (see FIG. 6). Data were obtained using 40 times objective, and mode field diameters were divided by 40. Typical coupling efficiency for the tapered lensed fiber is in a range from 80 to 90%, measured both by coupling two lensed fibers to each other and by coupling lensed fiber into Corning® SMF-28 core.

There are a variety of practical applications for the lensed fiber of the invention. The lensed fiber can be used as an imaging lens to focus light onto an optical device, such as a receiver or a detector or a core of a planar waveguide device with small delta n. In these applications, light traveling down the core of the optical fiber diverges upon entering the lens and is focused into a spot on the optical device upon exiting the lens. The lens geometry can be selected such that the desired spot size is formed on the optical device. The lensed fiber could also be used as a condenser. In this case, the light could be coming from an area on an optical device, such as an emitter or a planar waveguide. The lens would collect the light from the optical device and focus the light into the core of the optical fiber. The lensed fiber could also be used as a condenser where the light is coming from a fiber at a divergence angle that is equal to or smaller than the acceptable angle of the lens, and the lens is imaging the light into the core of the fiber.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A focusing lensed fiber, comprising:
an optical fiber terminated with a lens, the lens having a distance to beam waist greater than Rayleigh range.

2. The focusing lensed fiber of claim 1, wherein the lens has a f-number greater than one.

3. The focusing lensed fiber of claim 1, wherein the distance to beam waist is greater than 100 μm

4. The focusing lensed fiber of claim 1, wherein the lens comprises silica.

5. The focusing lensed fiber of claim 1, wherein the lens comprises doped silica.

6. The focusing lensed fiber of claim 1, wherein a diameter of the lens is larger than a diameter of the optical fiber.

7. The focusing lensed fiber of claim 1, wherein a diameter of the lens is smaller than a diameter of the optical fiber.

8. The focusing lensed fiber of claim 1, wherein a diameter of the lens is the same as the diameter of the optical fiber.

9. The focusing lensed fiber of claim 1, wherein the lens has a back-reflection greater than −55 dB.

10. The focusing lensed fiber of claim 9, wherein a surface of the lens is coated with an anti-reflection coating.

11. A method for forming a lensed fiber, comprising:
resistibly heating a selected region of a glass fiber for a predetermined time; and
pulling on the glass fiber while resistibly heating to form a convex surface at the selected region.

12. The method of claim 11, wherein the glass fiber is a coreless fiber.

13. The method of claim 12, further comprising splicing an optical fiber to the glass fiber.

14. The method of claim 13, wherein pulling on the glass fiber comprises pulling on the glass fiber in a direction away from a splice formed between the glass fiber and the optical fiber.

15. The method of claim 11, wherein the glass fiber is a single-mode fiber and the convex surface is formed at a tip of the glass fiber.

16. The method of claim 11, wherein the glass fiber is a multimode fiber and the convex surface is formed at a tip of the glass fiber.

17. The method of claim 11, wherein the glass fiber is a polarization-maintaining fiber and the convex surface is formed at a tip of the glass fiber.

18. The method of claim 11, further comprising enlarging a radius of curvature of the convex surface by resistively heating the convex surface.

19. The method of claim 18, wherein resistively heating the convex surface comprises moving a resistive heat source in a direction toward the convex surface as the radius of curvature of the convex surface is enlarged.
